(19) United States
(12) Patent Application Publication
(10) Pub. No.: US 2026/0264478 A1
(43) Pub. Date: Sep. 10, 2026

(54) THERMAL MANAGEMENT FLUID MODULE FOR AUTOMOBILE

(71) Applicant: HANON SYSTEMS, Daejeon (KR)

(72) Inventors: Min Sung KIM, Daejeon (KR); Seong Hun KIM, Daejeon (KR); Kyung Tae NOH, Daejeon (KR); Hae Jun LEE, Daejeon (KR)

(21) Appl. No.: 19/163,617

(22) PCT Filed: Apr. 12, 2024
(86) PCT No.: PCT/KR2024/004940

§ 371 Date: Sep. 9, 2025

(30) Foreign Application Priority Data
Apr. 20, 2023 (KR) 10-2023-0052106

(51) Int. Cl. B60H 1/32

(52) U.S. Cl. CPC B60H 1/3227

(57) ABSTRACT

An embodiment relates to a thermal management fluid module for an automobile, the module being used in a vehicle interior and an electrical equipment thermal management system, and including a plurality of heat exchangers. The module includes a first manifold plate to which the heat exchangers are connected. The heat exchanger for exchanging heat with cooling water may be arranged on one side of the first manifold plate, and the heat exchanger for exchanging heat with a refrigerant may be arranged on the other side thereof.

### TECHNICAL FIELD

The present invention relates to a thermal management fluid module for an automobile, and more specifically, to a thermal management fluid module for an automobile in which components such as a heat exchanger and valves are modularized as one component.

### BACKGROUND ART

According to the trend toward environmentally friendly industrial development and the development of energy sources that replace fossil raw materials, electric vehicles and hybrid vehicles are fields that have been attracting the most attention in the automobile industry in recent years. In electric vehicles and hybrid vehicles, batteries are mounted and provide driving forces, and the batteries are used for not only driving but also cooling and heating.

In a vehicle in which batteries are used to provide a driving force, using the batteries as a heat source for heating and cooling means that a driving distance is reduced by as much as the used amount. In order to overcome the above-described problems, a method of applying a thermal management system, which is conventionally and widely used in home cooling and heating systems, to vehicles has been proposed.

For reference, a thermal management system absorbs heat at a low temperature and transfers the absorbed heat to an area at a high temperature. An example of the thermal management system has a cycle in which a liquid refrigerant evaporates in an evaporator, absorbs heat from surroundings to become a gas, and then emits heat to the surroundings using a condenser to be liquified. When this is applied to electric vehicle or hybrid vehicle, this has an advantage of securing a heat source which is insufficient in the conventional air conditioner.

In order to improve the operational performance of such thermal management systems, vehicle interior and electric device thermal management systems are being introduced. In order to form a basic structure of a vehicle interior and electric device thermal management system, in which the conventional plate type economizer is used, components such as a condenser, a receiver dryer, a plate-type heat exchanger, an internal heat exchanger (IHX), and the like are needed. However, since such components are individually installed, spatial efficiency is degraded, and there are disadvantages in terms of packaging, costs, and workability.

### DETAILED DESCRIPTION OF INVENTION

### Technical Problem

The present invention is directed to providing a thermal management fluid module for an automobile, in which not only a refrigerant system but also a cooling water system are modularized in a vehicle interior and electric device thermal management system, and thus a volume and a weight of an entire module are reduced and the number of components is decreased, thereby reducing costs and forming refrigerant and cooling water flow paths with the shortest length.

In addition, the present invention is directed to providing a thermal management fluid module for an automobile in which overcooling is additionally performed by a sub-cooling part in a first heat exchanger and a total flow rate is increased at the same time in a thermal management system to improve heating performance (an increase in flow rate) and efficiency (an increase in overcooling) during heating and cooling performance (an increase in overcooling) during cooling.

In addition, one embodiment of the present invention is directed to providing a thermal management fluid module for an automobile capable of controlling the performance of a total thermal management system by controlling distribution amounts of divided refrigerants by controlling an opening degree of a first expansion valve.

In addition, one embodiment of the present invention is directed to providing a thermal management fluid module for an automobile in which a length of a flow path is reduced and the management of a cooling water flow path is easy because the cooling water flow path is changed in a lateral direction due to a cooling water supply module instead of the cooling water being supplied to a heat exchanger through a long pipe.

Objectives to be achieved by the embodiments of the present invention are not limited to the above-described objectives, and other objectives, which are not described above, may be clearly understood by those skilled in the art through the following specification.

### Technical Solution

A thermal management fluid module for an automobile, which includes a plurality of heat exchangers used in a vehicle interior and electric device thermal management system, according to one embodiment of the present invention includes a first manifold plate to which the heat exchangers are coupled, wherein one of the heat exchangers which perform heat exchange with cooling water may be disposed at one side based on the first manifold plate, and the heat exchanger which performs heat exchange with a refrigerant may be disposed at the other side. The thermal management fluid module may further include a cooling water supply module which supplies the cooling water which is heat-exchanged with the refrigerant introduced from the heat exchanger, wherein the cooling water supply module may be disposed close to the heat exchanger disposed at the other side of the first manifold plate.

A second manifold plate in which a flow path for the cooling water introduced from the cooling water supply module is formed may be disposed between the heat exchanger and the cooling water supply module.

A manifold communication portion through which the cooling water supplied from the cooling water supply module is introduced and discharged may be formed in the second manifold plate.

The cooling water supply module may be formed in a plate shape in which a cooling water flow path is formed, and a cooling water inlet and a cooling water outlet through which the cooling water is introduced and discharged may be provided at one side of the cooling water supply module.

The heat exchangers may include a first heat exchanger in which a high temperature refrigerant flows and a second heat exchanger in which a low temperature refrigerant flows, wherein both the first heat exchanger and the second heat exchanger may be coupled to one surface of the first manifold plate.

The thermal management fluid module may further include an internal heat exchanger in which a refrigerant discharged from an economizer is heat-exchanged with a refrigerant heat-exchanged in and discharged from the second heat exchanger.

The economizer and the internal heat exchanger may be coupled to be stacked in a horizontal or vertical direction.

The economizer and the internal heat exchanger may be stacked such that the economizer is disposed at a lower side and the internal heat exchanger is disposed at an upper side.

The economizer and the internal heat exchanger may be separately disposed and coupled to the first manifold plate.

The first heat exchanger and the second heat exchanger may be coupled to the one surface of the first manifold plate, and the receiver dryer, the economizer, and the internal heat exchanger may be coupled to the other surface of the first manifold plate.

A sub-cooling part for increasing an overcooling extent of a refrigerant discharged from the receiver dryer may be formed in the first heat exchanger.

A first expansion valve, which expands a refrigerant discharged from the first heat exchanger and allows the refrigerant to be introduced into the economizer, may be coupled to the first manifold plate.

The refrigerant discharged from the first heat exchanger may be divided and heat-exchanged, some of the refrigerant may be expanded by the first expansion valve, and the rest of the refrigerant may be heat-exchanged while passing through the economizer and the internal heat exchanger.

The refrigerant expanding in the first expansion valve may be heat-exchanged in the economizer and then may be introduced into a compressor, and the refrigerant which is not expanded in the first expansion valve may be heat-exchanged with the refrigerant, which is heat-exchanged in the second heat exchanger and introduced, in the internal heat exchanger.

Distribution of the refrigerant discharged from the first heat exchanger may be controlled according to an opening degree of the first expansion valve.

A second expansion valve which expands a refrigerant discharged from the internal heat exchanger and allows the refrigerant to be introduced into the second heat exchanger may be coupled to the first manifold plate.

The first expansion valve may be coupled to the other surface of the first manifold plate, and the second expansion valve may be coupled to the one surface of the first manifold plate.

A refrigerant introduced into the first heat exchanger and the second heat exchanger may flow downward from an upper side to be heat-exchanged with the cooling water, and a refrigerant introduced into the economizer and the internal heat exchanger may flow upward from a lower side.

### Advantageous Effects

According to one embodiment of the present invention, by modularizing not only a refrigerant system but also a cooling water system in a vehicle interior and electric device thermal management system, a volume and a weight of an entire module can be reduced and the number of components can be decreased, thereby reducing costs and forming refrigerant and a cooling water flow path with the shortest length.

In addition, according to one embodiment of the present invention, heating performance (an increase in flow rate) and efficiency (an increase in overcooling) can be improved during heating, and cooling performance (an increase in overcooling) can be improved during cooling by additionally overcooling using a sub-cooling part in a first heat exchanger and increasing a total flow rate at the same time in a thermal management system.

In addition, according to one embodiment of the present invention, the performance of a total thermal management system can be controlled by controlling distribution amounts of divided refrigerants according to an opening degree of a first expansion valve.

In addition, according to one embodiment of the present invention, since a cooling water flow path is changed in a lateral direction due to a cooling water supply module instead of cooling water being supplied to a heat exchanger through a long pipe, a length of a flow path can be reduced, and the management of the cooling water flow path is easy.

### DESCRIPTION OF DRAWINGS

FIG. 1 is a perspective view illustrating a thermal management fluid module for an automobile according to one embodiment of the present invention.

FIG. 2 is a plan view illustrating the thermal management fluid module for an automobile according to one embodiment of the present invention.

FIG. 3 is a view illustrating a structure of a first heat exchanger and a receiver dryer and a flow of a refrigerant of the thermal management fluid module for an automobile according to one embodiment of the present invention.

FIG. 4 is a view illustrating a structure of an economizer, an internal heat exchanger, and a second heat exchanger and a flow of the refrigerant of the thermal management fluid module for an automobile according to one embodiment of the present invention.

FIG. 5 is a view illustrating a flow of the refrigerant through the economizer and the internal heat exchanger of the thermal management fluid module for an automobile according to one embodiment of the present invention.

FIG. 6 is a view illustrating a structure of the economizer and the internal heat exchanger of the thermal management fluid module for an automobile according to one embodiment of the present invention.

FIG. 7 is a cross-sectional view illustrating a portion connected to a cooling water supply module in the thermal management fluid module for an automobile according to one embodiment of the present invention.

FIG. 8 is a view illustrating a flow of cooling water in the cooling water supply module of the thermal management fluid module for an automobile according to one embodiment of the present invention.

FIG. 9 is a perspective view illustrating a thermal management fluid module for an automobile according to another embodiment of the present invention.

FIG. 10 is a view illustrating a flow of a refrigerant of an economizer and an internal heat exchanger of the thermal management fluid module for an automobile according to another embodiment of the present invention.

### MODES OF THE INVENTION

Since the present invention may be variously modified and have several embodiments, specific embodiments will be illustrated in the accompanying drawings and described in detail. However, this is not intended to limit the present invention to the specific embodiments, and it should be appreciated that all changes, equivalents, and substitutes falling within the spirit and technical scope of the present invention are encompassed in the present invention. In the description of the embodiments, certain detailed descriptions of the related art will be omitted when it is deemed that they may unnecessarily obscure the gist of the present invention.

Terms such as “first” and “second” may be used to describe various components, but the components are not limited by the above terms. These terms are used only to distinguish one component from another.

Terms used herein are only for the purpose of describing the specific embodiments and are not intended to limit the present invention. Singular forms are intended to include the plural forms, unless the context clearly indicates otherwise. In the present specification, it should be understood that the terms “comprise,” “comprising,” “include,” and/or “including” specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected but may also mean that two or more components are indirectly connected through other components, physically connected and also electrically connected, or integrated as one component even when referred to by different names according to locations or functions thereof.

Hereinafter, one embodiment of a thermal management fluid module for an automobile will be described in detail with reference to the accompanying drawings, and when the embodiment is described with reference to the accompanying drawings, components that are the same or correspond to each other will be denoted by the same reference numerals, and redundant description thereof will be omitted.

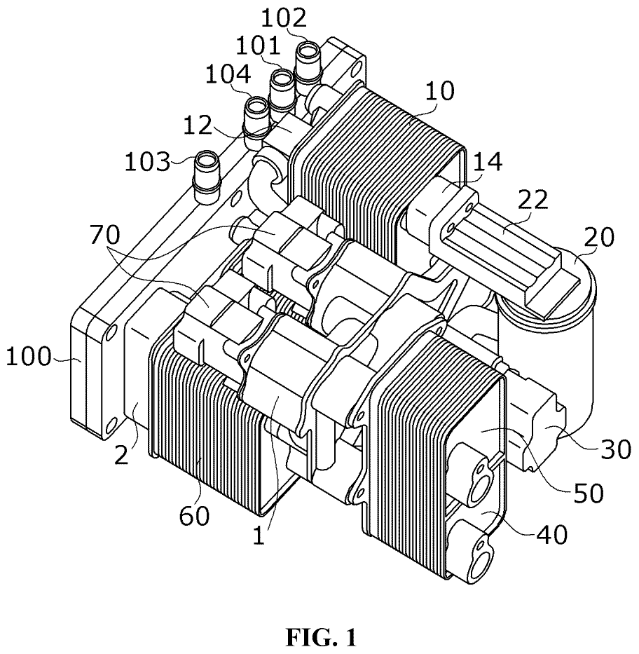

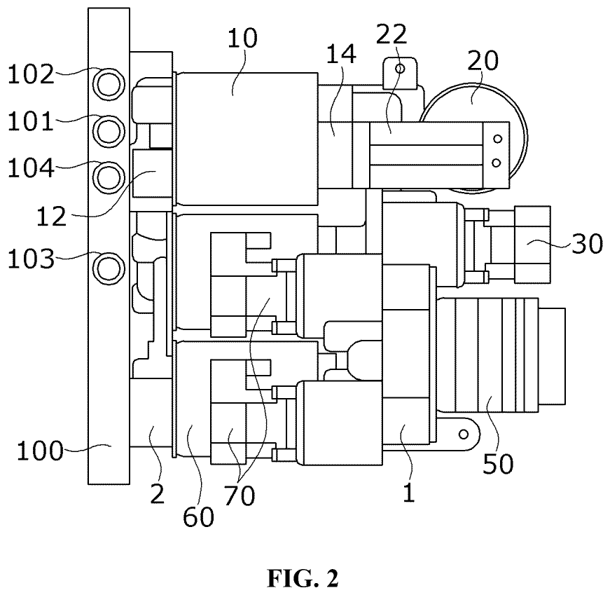

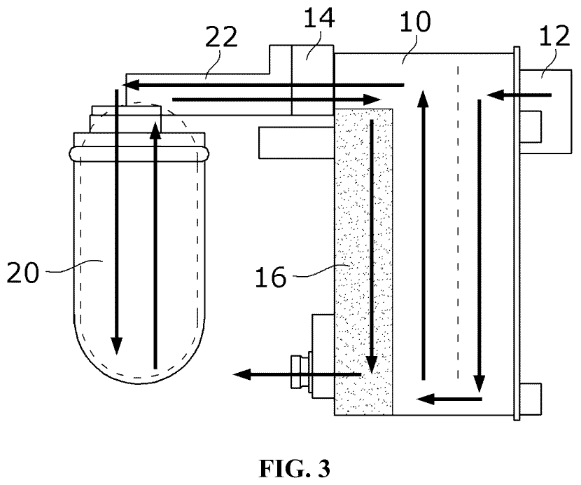

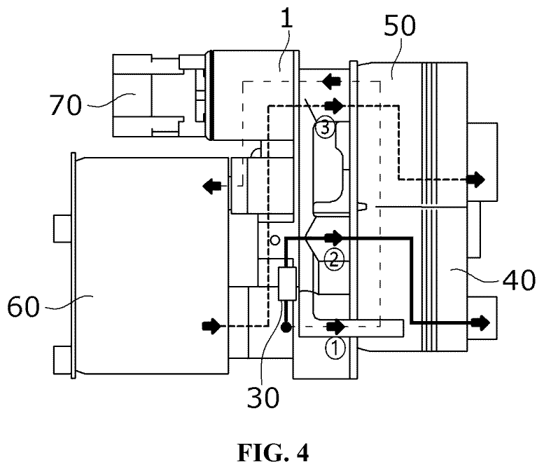

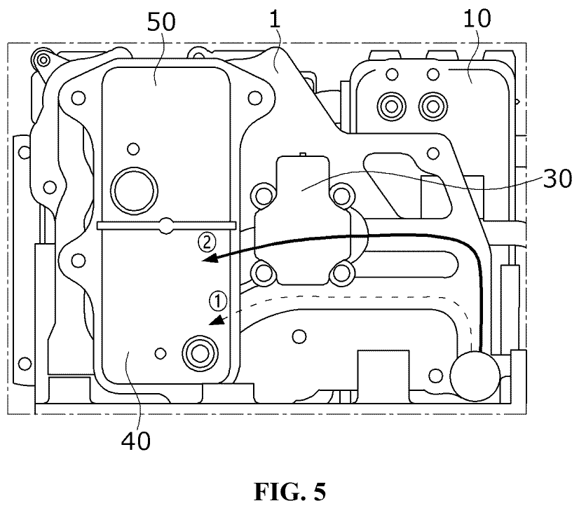

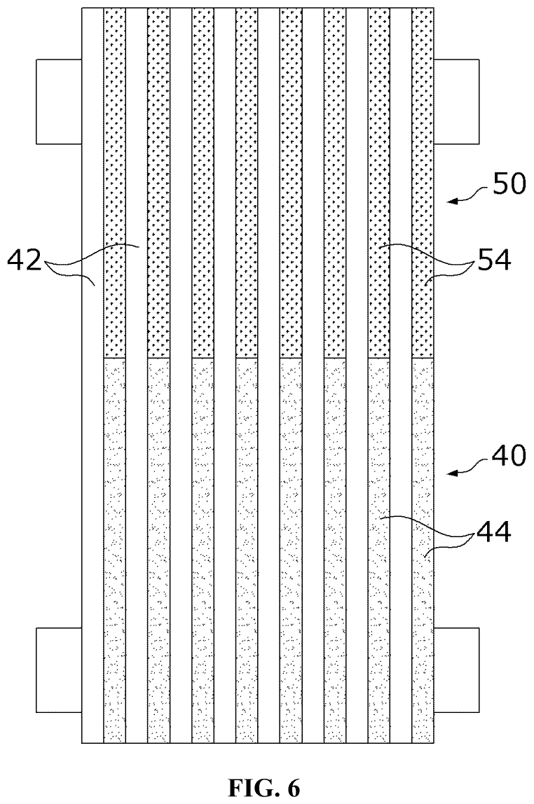

FIG. 1 is a perspective view illustrating a thermal management fluid module for an automobile according to one embodiment of the present invention, and FIG. 2 is a plan view illustrating the thermal management fluid module for an automobile according to one embodiment of the present invention. FIG. 3 is a view illustrating a structure of a first heat exchanger and a receiver dryer and a flow of a refrigerant of the thermal management fluid module for an automobile according to one embodiment of the present invention, and FIG. 4 is a view illustrating a structure of an economizer, an internal heat exchanger, and a second heat exchanger and a flow of the refrigerant of the thermal management fluid module for an automobile according to one embodiment of the present invention. FIG. 5 is a view illustrating a flow of the refrigerant through the economizer and the internal heat exchanger of the thermal management fluid module for an automobile according to one embodiment of the present invention, and FIG. 6 is a view illustrating a structure of the economizer and the internal heat exchanger of the thermal management fluid module for an automobile according to one embodiment of the present invention.

According to the illustrated drawings, the thermal management fluid module for an automobile according to one embodiment of the present invention, which includes a plurality of heat exchangers used in a vehicle interior and an electric device thermal management system, may include a first manifold plate 1 to which the heat exchangers are coupled. The heat exchanger which performs heat exchange with cooling water may be disposed at one side based on the first manifold plate 1, and the heat exchanger which performs heat exchange with the refrigerant may be disposed at the other side.

In addition, the thermal management fluid module for an automobile may further include a cooling water supply module 100 which supplies the cooling water which is heat-exchanged with the refrigerant introduced into the heat exchanger, and the cooling water supply module 100 may be disposed close to the heat exchanger disposed at the other side of the first manifold plate 1.

The first manifold plate 1 has substantially a plate shape in which a fluid flow path is formed and which has a predetermined thickness. As a first heat exchanger 10, a second heat exchanger 60, and expansion valves 30 and 70, which are heat exchange apparatuses of the thermal management system, are coupled to and modularized with the first manifold plate 1, a product manufacturing man-hours can be reduced, and a man-hours of a vehicle assembly line can also be reduced. In addition, since the first manifold plate 1 serves functions of piping, fittings, and housing simultaneously, costs can be reduced, and workability can be improved.

The first manifold plate 1 may include an assembly including a bottom plate and a top plate and may be manufactured by a method of coupling using brazing, structural adhesives, a gasket, etc. In addition, aluminum, thermos-plastic, or stainless steel may be variously applied as a material of the first manifold plate 1 according to objectives and functions.

In the present embodiment, by forming both the first heat exchanger 10 and the second heat exchanger 60 constituting the vehicle interior and electric device thermal management system to be coupled to one surface of the first manifold plate 1 and forming a receiver dryer 20, an economizer 40, and an internal heat exchanger (IHX) 50 to be coupled to the other surface of the first manifold plate 1, costs and a weight are reduced, and workability is improved. That is, by arranging the first heat exchanger 10 and the second heat exchanger 60 which perform heat exchange with the refrigerant at one side based on the first manifold plate 1 and arranging the receiver dryer 20, the economizer 40, and the IHX 50 at the other side, a structure of flow paths of the refrigerant and the cooling water can be minimized.

In the present embodiment, a water cooling condenser may be used as the first heat exchanger 10, and a chiller may be used as the second heat exchanger 60. The water cooling condenser serves to allow a high temperature and high pressure gaseous fluid (refrigerant) discharged from a compressor or internal condenser to be heat-exchanged with external heat to condense the high temperature and high pressure gaseous fluid (refrigerant) into a high pressure liquid. The chiller is an apparatus to which a low temperature and low pressure fluid is supplied and in which the low temperature and low pressure fluid is heat-exchanged with the cooling water flowing through a cooling water circulation path (not shown), and the cold cooling water heat-exchanged in the chiller may circulate the cooling water circulation path and is heat-exchanged with a battery.

The first heat exchanger 10 serves to allow a high temperature and high pressure gaseous fluid (refrigerant) discharged from the compressor (not shown) to be heat-exchanged with external heat to condense the high temperature and high pressure gaseous fluid (refrigerant) into a high pressure liquid. The first heat exchanger 10 includes refrigerant ports through which the refrigerant is introduced and discharged. The refrigerant ports include a first refrigerant inlet 12 provided in one side surface of the first heat exchanger 10 and a first refrigerant outlet 14 provided in the other side surface thereof. The first refrigerant inlet 12 is a portion through which the high temperature and high pressure refrigerant discharged from the compressor is introduced, and the first refrigerant outlet 14 is a portion through which the refrigerant heat-exchanged in the first heat exchanger 10 is discharged.

Referring to FIG. 3, the high temperature and high pressure refrigerant introduced through the first refrigerant inlet 12 disposed at an upper side may be heat-exchanged while flowing downward and then flow upward in the first heat exchanger 10. The refrigerant heat-exchanged may be discharged toward the receiver dryer 20 through the first refrigerant outlet 14 disposed at an opposite upper side.

The receiver dryer 20 serves to store a surplus refrigerant which may be generated in the thermal management fluid module. A refrigerant flow part 22, which is a passage through which the refrigerant is introduced and discharged, is provided on the receiver dryer 20. The refrigerant discharged from the receiver dryer 20 may be introduced back into the first heat exchanger 10, and a sub-cooling part 16 for increasing an overcooling extent of the liquid refrigerant discharged from the receiver dryer 20 may be formed in the first heat exchanger 10. When the overcooling extent of the refrigerant increases in the sub-cooling part 16, the performance of the thermal management system can be improved. The refrigerant discharged from the sub-cooling part 16 may be introduced into the economizer 40 through the first manifold plate 1 in order to secure an additional overcooling extent.

As the overcooling is additionally achieved by the sub-cooling part 16 in the first heat exchanger 10 in the thermal management system, and a total flow rate is increased at the same time, heating performance (an increase in flow rate) and efficiency (an increase in overcooling) can be improved during heating, and cooling performance (an increase in overcooling) can be improved during cooling.

Referring to FIGS. 4 and 5, the refrigerant heat-exchanged in the first heat exchanger 10 may be divided into two refrigerants from one refrigerant in the first manifold plate 1 and introduced toward the economizer 40. First, a \textcircled{1} refrigerant introduced into the economizer 40 without an additional expansion process is heat-exchanged with a \textcircled{3} refrigerant, which is in a state different from that of the \textcircled{1} refrigerant, in the IHX 50 located at the upper side, and, in this case, the \textcircled{3} refrigerant is a refrigerant heat-exchanged in and discharged from the second heat exchanger 60. In addition, the \textcircled{1} refrigerant expands in a second expansion valve 70, then is introduced into the second heat exchanger 60, and is heat-exchanged.

Another \textcircled{2} refrigerant divided in the first manifold plate 1 may expand in a first expansion valve 30 and then is introduced into the economizer 40. The \textcircled{2} refrigerant introduced into the economizer 40 may be heat-exchanged and then introduced into the compressor.

Meanwhile, in the present embodiment, in the first heat exchanger 10 and the second heat exchanger 60, a refrigerant flow path is formed downward from an upper side, however, in the economizer 40 and the IHX 50, a refrigerant flow path for a main refrigerant \textcircled{1} refrigerant) introduced into the second heat exchanger 60 may be formed upward from a lower side. Since cooling water heat-exchanged with a refrigerant in the second heat exchanger 60 flows upward from a lower side (it is advantageous for removing air), the refrigerant is introduced into an upper portion and discharged downward in order to generate a counter-flow of the cooling water.

In addition, since the refrigerant heat-exchanged in the economizer 40 should pass through the IHX 50, the IHX 50 may be disposed above the economizer 40 in order to form a refrigerant flow path with the shortest length. That is, the economizer 40 and the IHX 50 may be coupled to be stacked in a horizontal or vertical direction.

When the economizer 40 and the IHX 50 are integrally formed to be stacked as described above, since the refrigerant heat-exchanged in the economizer 40 does not need to pass through the first manifold plate 1 to be heat-exchanged in the IHX 50, a refrigerant path can be shortened, and unnecessary waste of heat energy can be prevented. In addition, since the economizer 40 and the IHX 50 are integrally formed, costs and a weight can be reduced.

The \textcircled{1} refrigerant and the \textcircled{2} refrigerant are divided in the first manifold plate 1 as described above, and the distribution of divided amounts in this case can be controlled according to an opening degree of the first expansion valve 30. That is, when the first expansion valve 30 is widely opened, a flow rate of the \textcircled{2} refrigerant increases, and when the first expansion valve 30 is narrowly closed, a flow rate of the \textcircled{2} refrigerant decreases due to resistance. When the distribution amounts of the divided refrigerants are controlled according to the opening degree of the first expansion valve 30, the performance of the total thermal management system can be controlled.

A low temperature and low pressure refrigerant is supplied to the second heat exchanger 60 and heat-exchanged with cooling water supplied from the cooling water supply module 100. The cold cooling water heat-exchanged in the second heat exchanger 60 may circulate a cooling water circulation path to be heat-exchanged with the battery. In the present embodiment, it is illustrated that two second heat exchangers 60 are disposed in the horizontal direction, but it is proposed as only one example, and only one second heat exchanger 60 may be disposed.

Referring to FIG. 6, the economizer 40 and the IHX 50 may include a main plate 42 which is stacked as a plurality of main plates 42 and through which a first refrigerant flows, first plates 44 each of which is stacked in each gap between the main plates 42 at a location corresponding to a lower portion of the main plate 42 and through which the divided first refrigerant flows, and second plates 54 each of which is stacked in each gap between the main plates 42 at a location corresponding to an upper portion of the main plate 42 and through which a second refrigerant flows.

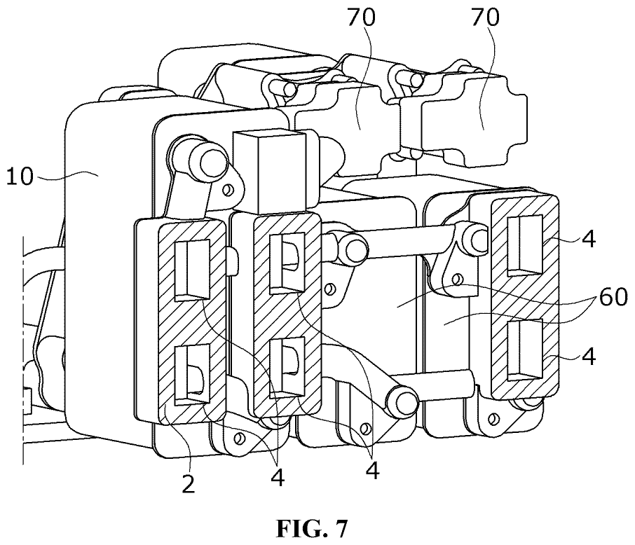

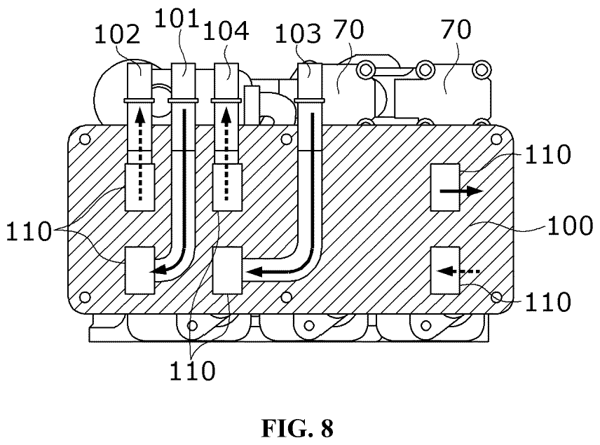

FIG. 7 is a cross-sectional view illustrating a portion connected to the cooling water supply module in the thermal management fluid module for an automobile according to one embodiment of the present invention, and FIG. 8 is a view illustrating a flow of the cooling water in the cooling water supply module of the thermal management fluid module for an automobile according to one embodiment of the present invention.

Referring to the drawings, a second manifold plate 2 forming a flow path for the cooling water introduced from the cooling water supply module 100 may be disposed between the heat exchangers 10 and 60 and the cooling water supply module 100. The second manifold plate 2 has substantially a plate shape, in which a fluid flow path is formed and which has a predetermined thickness, like the first manifold plate 1. Since the second manifold plate 2 and the first manifold plate 1 may be coupled to and modularized with not only the first heat exchanger 10, the second heat exchanger 60, and the expansion valves 30 and 70, which are the heat exchanging apparatus of the thermal management system, but also the cooling water supply module 100, a product manufacturing man-hours can be reduced, and a man-hours of a vehicle assembly line can also be reduced.

In the present embodiment, as described above, the thermal management system can be modularized by arranging the first manifold plate 1 and the second manifold plate 2 to be spaced a predetermined distance from each other and to be coupled to not only the first heat exchanger 10, the second heat exchanger 60, and the expansion valves 30 and 70 but also the cooling water supply module 100 for supplying the cooling water. As the cooling water supply module 100 is disposed close to the first heat exchanger 10 and the second heat exchanger 60 which performs heat exchange with the cooling water, a length of a pipe through which the cooling water is supplied can be minimized.

A manifold communication portion 4, through which the cooling water supplied from the cooling water supply module 100 is introduced and discharged, may be formed in one surface of the second manifold plate 2 to be open. Ports to which separate pipes may be connected should be provided in the first heat exchanger 10 and the second heat exchanger 60 in order to supply the cooling water to the first heat exchanger 10 and the second heat exchanger 60, and since the cooling water introduced through the second manifold plate 2 may be directly supplied to the first heat exchanger 10 and the second heat exchanger 60 in the present embodiment, a total volume of the module can decrease, and interference with surrounding electric devices of a vehicle can also be minimized. In addition, since a flow path for the cooling water is changed in a lateral direction instead of the cooling water being supplied to the first heat exchanger 10 and the second heat exchanger 60 in a front direction through a long pipe, a length of the flow path is reduced, and the management of the flow path for the cooling water is easy.

The cooling water supply module 100 is formed in a plate shape in which a cooling water flow path is formed. Cooling water inlets 101 and 103 and cooling water outlets 102 and 104 through which the cooling water is introduced and discharged are provided at one side of the cooling water supply module 100, that is, in an upper side surface of the cooling water supply module 100. The cooling water inlets 101 and 103 and the cooling water outlets 102 and 104 are provided to protrude outward, and pipes for supply of the cooling water may be connected to the cooling water inlets 101 and 103 and the cooling water outlets 102 and 104.

Solid lines in FIG. 8 indicate a flow path for the cooling water introduced into the cooling water supply module 100, and dotted lines indicate a flow path for the cooling water discharged from the cooling water supply module 100. A first cooling water inlet 101 is an inlet through which the cooling water to be introduced into the first heat exchanger 10 is introduced, and a first cooling water outlet 102 is an outlet through which the cooling water heat-exchanged in the first heat exchanger 10 is discharged. A supply communication portion 110 into which the cooling water introduced though the first cooling water inlet 101 flows to the manifold communication portion 4 may be formed in the water supply module 100. That is, the cooling water introduced through the first cooling water inlet 101 may flow through the supply communication portion 110 and the manifold communication portion 4 along an internal flow path, may be heat-exchanged in the first heat exchanger 10, and then may be discharged through the manifold communication portion 4, the supply communication portion 110, and the first cooling water outlet 102.

A second cooling water inlet 103 and a second cooling water outlet 104 through which the cooling water to be heat-exchanged in the second heat exchanger 60 is introduced and discharged are provided in the cooling water supply module 100. In the present embodiment, since two second heat exchangers 60 are disposed, it is illustrated that the supply communication portion 110 are formed at two locations.

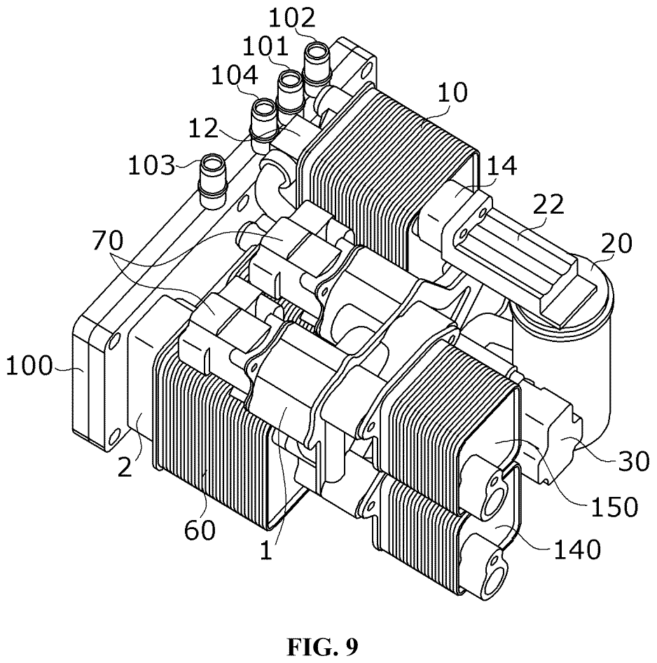

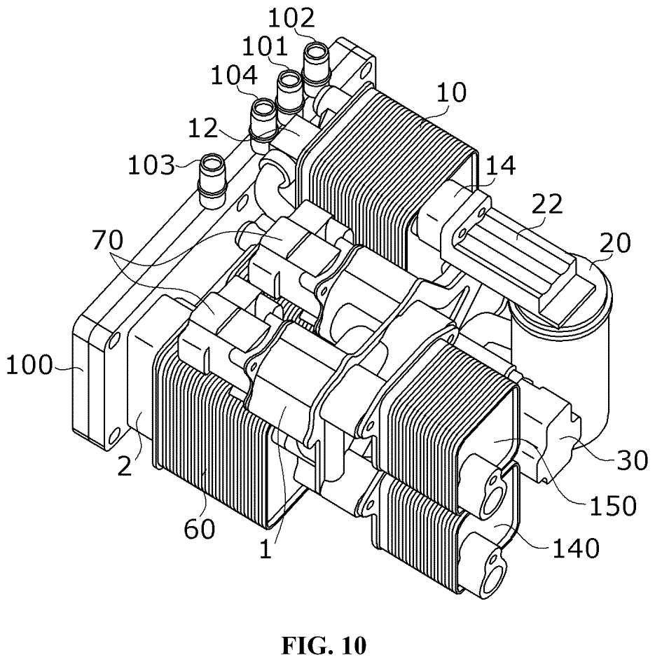

FIG. 9 is a perspective view illustrating a thermal management fluid module for an automobile according to another embodiment of the present invention, and FIG. 10 is a view illustrating a flow of a refrigerant of an economizer and an internal heat exchanger of the thermal management fluid module for an automobile according to another embodiment of the present invention. In the present drawings, components that are the same as those in the above-described embodiment are denoted by the same reference numerals, and changed components are denoted by reference numerals starting from one hundred.

Referring to the drawings, in the present embodiment, an economizer 140 and an IHX 150 are provided to be individually disposed without being integrally formed. The economizer 140 and the IHX 150 may be disposed at an upper side and a lower side for a flow of the refrigerant.

In this case, the refrigerant heat-exchanged in a first heat exchanger 10 may be divided into two refrigerants in a first manifold plate 1 and introduced into the economizer 140. First, a \textcircled{1} refrigerant introduced into the economizer 140 without an additional expansion process is heat-exchanged with a \textcircled{3} refrigerant, which is in a state different from that of the \textcircled{1} refrigerant, in the IHX 50 located at the upper side, and in this case, the \textcircled{3} refrigerant is a refrigerant heat-exchanged in and discharged from a second heat exchanger 60. In addition, the \textcircled{1} refrigerant expands in a second expansion valve 70, then is introduced into the second heat exchanger 60, and is heat-exchanged.

Another \textcircled{2} refrigerant divided in the first manifold plate 1 may expand in a first expansion valve 30 and then is introduced into the economizer 140. The \textcircled{2} refrigerant introduced into the economizer 140 may be heat-exchanged with the \textcircled{1} refrigerant, which is not expanded, and then introduced into a compressor.

Meanwhile, in the present embodiment, in the first heat exchanger 10 and the second heat exchanger 60, a refrigerant flow path is formed downward from an upper side, however, in the economizer 140 and the IHX 150, a refrigerant flow path for a main refrigerant \textcircled{1} refrigerant) introduced into the second heat exchanger 60 may be formed upward from a loser side. Since cooling water heat-exchanged with the refrigerant in the second heat exchanger 60 flows upward from the lower side (it is advantageous for removing air), the refrigerant should be introduced into an upper portion and discharged downward in order to generate a counter-flow of the cooling water.

In the present embodiment, it is illustrated that the refrigerant flows in a diagonal direction to be easily heat-exchanged in the economizer 140 and the IHX 150, but the present invention is not limited thereto, and the refrigerant may also flow in a vertical direction.

While the present invention has been described above with reference to exemplary embodiments, it may be understood by those skilled in the art that various modifications and changes of the present invention may be made within a range not departing from the spirit and scope of the present invention defined by the appended claims.

[Reference Numerals]

| | |
|---|---|
| 1: FIRST MANIFOLD PLATE | 2: SECOND MANIFOLD PLATE |
| 4: MANIFOLD COMMUNICATION PORTION | 10: FIRST HEAT EXCHANGER |
| 12: FIRST REFRIGERANT INLET | 14: FIRST REFRIGERANT OUTLET |
| 20: RECEIVER DRYER | 22: REFRIGERANT FLOW PART |
| 30: FIRST EXPANSION VALVE | 40: ECONOMIZER |
| 42: MAIN PLATE | 44: FIRST PLATE |
| 46: SECOND PLATE | 50: INTERNAL HEAT EXCHANGER |
| 60: SECOND HEAT EXCHANGER | 70: SECOND EXPANSION VALVE |
| 100: COOLING WATER SUPPLY MODULE | 101: FIRST COOLING WATER INLET |
| 102: FIRST COOLING WATER OUTLET | 103: SECOND COOLING WATER INLET |
| 104: SECOND COOLING WATER OUTLET | 110: SUPPLY COMMUNICATION |
| | PORTION |

1. A thermal management fluid module for an automobile that includes a plurality of heat exchangers used in a vehicle interior and electric device thermal management system, the thermal management fluid module comprising a first manifold plate to which the heat exchangers are coupled,
wherein one of the heat exchangers which performs heat exchange with cooling water is disposed at one side based on the first manifold plate, and
the heat exchanger which performs heat exchange with a refrigerant is disposed at the other side.

2. The thermal management fluid module of claim 1, further comprising a cooling water supply module which supplies the cooling water which is heat-exchanged with the refrigerant introduced from the heat exchanger,
wherein the cooling water supply module is disposed close to the heat exchanger disposed at the other side of the first manifold plate.

3. The thermal management fluid module of claim 2, wherein a second manifold plate in which a flow path for the cooling water introduced from the cooling water supply module is formed is disposed between the heat exchanger and the cooling water supply module.

4. The thermal management fluid module of claim 3, wherein a manifold communication portion through which the cooling water supplied from the cooling water supply module is introduced and discharged is formed in the second manifold plate.

5. The thermal management fluid module of claim 4, wherein:
the cooling water supply module is formed in a plate shape in which a cooling water flow path is formed; and
a cooling water inlet and a cooling water outlet through which the cooling water is introduced and discharged are provided at one side of the cooling water supply module.

6. The thermal management fluid module of claim 2, wherein the heat exchangers include:
a first heat exchanger in which a high temperature refrigerant flows; and
a second heat exchanger in which a low temperature refrigerant flows,
wherein both the first heat exchanger and the second heat exchanger are coupled to one surface of the first manifold plate.

7. The thermal management fluid module of claim 6, further comprising an internal heat exchanger in which a refrigerant discharged from an economizer is heat-exchanged with a refrigerant heat-exchanged in and discharged from the second heat exchanger.

8. The thermal management fluid module of claim 7, wherein the economizer and the internal heat exchanger are coupled to be stacked in a horizontal or vertical direction.

9. The thermal management fluid module of claim 7, wherein the economizer and the internal heat exchanger are stacked such that the economizer is disposed at a lower side and the internal heat exchanger is disposed at an upper side.

10. The thermal management fluid module of claim 7, wherein the economizer and the internal heat exchanger are separately disposed and coupled to the first manifold plate.

11. The thermal management fluid module of claim 7, wherein:
the first heat exchanger and the second heat exchanger are coupled to the one surface of the first manifold plate; and
a receiver dryer, the economizer, and the internal heat exchanger are coupled to the other surface of the first manifold plate.

12. The thermal management fluid module of claim 11, wherein a sub-cooling part for increasing an overcooling extent of a refrigerant discharged from the receiver dryer is formed in the first heat exchanger.

13. The thermal management fluid module of claim 7, wherein a first expansion valve, which expands a refrigerant discharged from the first heat exchanger and allows the refrigerant to be introduced into the economizer, is coupled to the first manifold plate.

14. The thermal management fluid module of claim 13, wherein:
the refrigerant discharged from the first heat exchanger is divided and heat-exchanged;
some of the refrigerant is expanded by the first expansion valve; and
the rest of the refrigerant is heat-exchanged while passing through the economizer and the internal heat exchanger.

15. The thermal management fluid module of claim 14, wherein:
the refrigerant expanding in the first expansion valve is heat-exchanged in the economizer and then introduced into a compressor; and
the refrigerant which is not expanded in the first expansion valve is heat-exchanged with the refrigerant, which is heat-exchanged in the second heat exchanger and introduced, in the internal heat exchanger.

16. The thermal management fluid module of claim 13, wherein distribution of the refrigerant discharged from the first heat exchanger is controlled according to an opening degree of the first expansion valve.

17. The thermal management fluid module of claim 13, wherein a second expansion valve which expands a refrigerant discharged from the internal heat exchanger and allows the refrigerant to be introduced into the second heat exchanger is coupled to the first manifold plate.

18. The thermal management fluid module of claim 17, wherein:
the first expansion valve is coupled to the other surface of the first manifold plate; and
the second expansion valve is coupled to the one surface of the first manifold plate.

19. The thermal management fluid module of claim 7, wherein:
a refrigerant introduced into the first heat exchanger and the second heat exchanger flows downward from an upper side to be heat-exchanged with the cooling water; and
a refrigerant introduced into the economizer and the internal heat exchanger flows upward from a lower side.
